(19) United States
(12) Patent Application Publication
(10) Pub. No.: US 2018/0321782 A1
(43) Pub. Date: Nov. 8, 2018

(54) DISPLAY PANEL AND DISPLAY DEVICE

(71) Applicant: Shanghai AVIC OPTO Electronics Co., Ltd,, SHANGHAI (CN)

(72) Inventors: Feng QIN, SHANGHAI (CN); Shou Fu JIAN, SHANGHAI (CN); Zhi Qiang XIA, SHANGHAI (CN); Zhao Keng CAO, SHANGHAI (CN)

(73) Assignee: Shanghai AVIC OPTO Electronics Co., Ltd,, SHANGHAI (CN)

(21) Appl. No.: 16/022,641

(22) Filed: Jun. 28, 2018

(30) Foreign Application Priority Data
Jul. 26, 2017 (CN) 201710618678.X

(51) Int. Cl. G06F 3/041; G02F 1/1335; G02F 1/1362; G02F 1/1368; G02F 1/1333; G06F 3/047

(52) U.S. Cl. CPC G06F 3/0412; G02F 1/133512; G02F 1/136286; G06F 3/047; G02F 1/13338; G02F 1/133514; G02F 1/1368

(57) ABSTRACT

The present disclosure provides display panel and display device. The display panel includes: a plurality of sub-pixel units defined by the plurality of data lines intersecting the plurality of scanning lines in an insulation manner. The plurality of sub-pixel units constitutes a plurality of rendering pixel units arranged in an array. Each of the plurality of rendering pixel units includes at least two adjacent sub-pixel units in a row of sub-pixel units, and a number of sub-pixel units included in each of the plurality of rendering pixel units is smaller than a total number of colors corresponding to color resists in the display panel. In each row of sub-pixel units, at least two rendering pixel units of the plurality of rendering pixel units are disposed between two adjacent touch lines. In each column of rendering pixel units, each rendering pixel unit performs color rendering with its adjacent sub-pixel unit.

### CROSS-REFERENCE TO RELATED APPLICATIONS

The present disclosure claims priority to Chinese Patent Application No. 201710618678.X, filed on Jul. 26, 2017, the content of which is incorporated herein by reference in its entirety.

### TECHNICAL FIELD

The present disclosure relates to the field of display technologies, and in particular, to a display panel and a display device.

### BACKGROUND

In the related art, a display panel includes a plurality of sub-pixel units, each of which corresponds to a color resist having a respective one color, and multiple sub-pixel units corresponding to color resists having different colors constitute one pixel unit. The display panel performs light-synthesis in units of by taking one pixel unit as a unit, such that each pixel unit can display a corresponding color. For example, the color resists in the display panel have colors of red, blue, and green, that is, the display panel includes red resists, blue resists, and green resists. The display panel includes a plurality of sub-pixel units arranged in an array. Among each row of sub-pixel units, the red resists, the blue resists, and the green resists are alternately arranged. One pixel unit includes a sub-pixel unit corresponding to a red resist, a sub-pixel unit corresponding to a blue resist, and a sub-pixel unit corresponding to a green resist. Any two of the three sub-pixel units are adjacent to each other, that is, each pixel unit includes a set of color resists. In addition, in order to achieve the touch function, it is needed to provide a plurality of touch lines on the display panel, and each touch line corresponds to a column of pixel units. That is, sub-pixel units corresponding to a set of color resists correspond to one touch line. In the related art, sub-pixel units corresponding to a set of color resists correspond to one pixel unit, and each column of pixel units in the plurality of pixel units arranged in an array corresponds to one data line. Here, one pixel unit is a smallest light-synthesis unit for the display panel. Therefore, when the display panel has a fixed area, the number of pixel units will be increased when a pixel density of the display panel is increased, and thus the number of touch lines will be increased, thereby reducing an aperture ratio of the display panel and thus reducing brightness of the display panel.

### SUMMARY

The present disclosure provides a display panel and a display device, aiming to solve the problem in which when the display panel has a fixed area, brightness of the display panel is decreased when a pixel density of the display panel is increased.

The present disclosure provides a display panel. The display panel includes: a plurality of scanning lines extending along a first direction and arranged along a second direction; a plurality of data lines extending along the second direction and arranged along the first direction; a plurality of touch lines extending along the second direction and arranged along the first direction, and the first direction is perpendicular to and intersects the second direction; and a plurality of sub-pixel units defined by the plurality of data lines intersecting the plurality of scanning lines in an insulation manner, the plurality of sub-pixel units constituting a plurality of rendering pixel units arranged in an array. Each of the plurality of rendering pixel units includes at least two adjacent sub-pixel units in a row of sub-pixel units, and a number of sub-pixel units included in each of the plurality of rendering pixel units is smaller than a total number of colors corresponding to color resists in the display panel. In each row of sub-pixel units, at least two rendering pixel units of the plurality of rendering pixel units are disposed between two adjacent touch lines of the plurality of touch lines. In each column of rendering pixel units, each rendering pixel unit performs color rendering with its adjacent sub-pixel unit.

The present disclosure provides a display device including a display panel. The display panel includes: a plurality of scanning lines extending along a first direction and arranged along a second direction; a plurality of data lines extending along the second direction and arranged along the first direction; a plurality of touch lines extending along the second direction and arranged along the first direction, and the first direction is perpendicular to and intersects the second direction; and a plurality of sub-pixel units defined by the plurality of data lines intersecting the plurality of scanning lines in an insulation manner, the plurality of sub-pixel units constituting a plurality of rendering pixel units arranged in an array. Each of the plurality of rendering pixel units includes at least two adjacent sub-pixel units in a row of sub-pixel units, and a number of sub-pixel units included in each of the plurality of rendering pixel units is smaller than a total number of colors corresponding to color resists in the display panel. In each row of sub-pixel units, at least two rendering pixel units of the plurality of rendering pixel units are disposed between two adjacent touch lines of the plurality of touch lines. In each column of rendering pixel units, each rendering pixel unit performs color rendering with its adjacent sub-pixel unit.

### BRIEF DESCRIPTION OF DRAWINGS

The accompanying drawings used in the embodiments and in the related art are briefly introduced as follows.

FIG. 1 is a top view of a display panel according to an embodiment of the present disclosure;

FIG. 2 is a top view of another display panel according to an embodiment of the present disclosure;

FIG. 3 is a top view of another display panel according to an embodiment of the present disclosure;

FIG. 4 is a top view of still another display panel according to an embodiment of the present disclosure;

FIG. 5A is a cross-section view along line AA′ in FIG. 4:

FIG. 5B is a cross-section view along line BB′ in FIG. 4;

FIG. 6 is another cross-section view along line AA′ in FIG. 4;

FIG. 7 is a top view of still another display panel according to an embodiment of the present disclosure; and

FIG. 8 is a schematic diagram of a display device according to an embodiment of the present disclosure.

### DESCRIPTION OF EMBODIMENTS

For better illustrating the technical solutions of the present disclosure, embodiments of the present disclosure will be described in details in the following with reference to the accompanying drawings.

It should be understood that the described embodiments are merely exemplary embodiments of the present disclosure, which shall not be interpreted as limiting the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be noted that the expressions such as “upper”, “lower”, “left”, “right” and the like mentioned in embodiments of the present disclosure are described with reference to the placement status in the accompanying drawings, and should not be construed as limiting embodiments of the present disclosure. In addition, it should also be understood that, in the context, while referring to an element being formed “above” or “below” another element, it is possible that the element is directly formed “above” or “below” the other element, it is also possible that the element is formed “above” or “below” the other element via an intermediate element.

It should be noted that the embodiments in the present disclosure and the features in the embodiments may be combined with each other. The present disclosure will be described in details in the following with reference to the accompanying drawings and in combination with the embodiments.

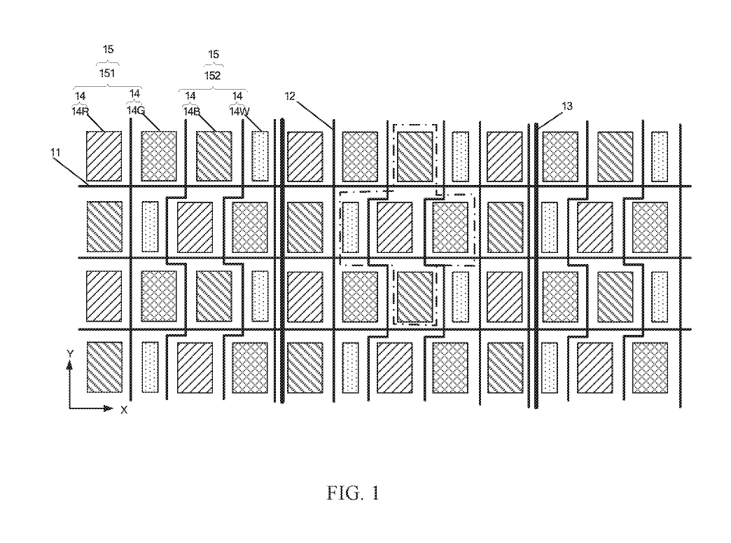

As shown in FIG. 1 (only illustrating a case including a first color resist, a second color resist, a third color resist, and a fourth color resist, and hereinafter, for example, the first color resist is a red resist, the second color resist is a blue resist, the third color resist is a green resist, and a fourth color resist is a white resist), FIG. 1 is a top view of a display panel according to an embodiment of the present disclosure. Here, the display panel includes: a plurality of scanning lines 11 extending along a first direction X and arranged along a second direction Y; a plurality of data lines 12 extending along the second direction Y and arranged along the first direction X; a plurality of touch lines 13 extending along the second direction Y and arranged along the first direction X. Here, the first direction X is perpendicular to and intersects the second direction Y. The display panel further includes a plurality of sub-pixel units 14, which is defined by the plurality of data lines 12 intersecting the plurality of scanning lines 11 in an insulation manner. The plurality of sub-pixel units 14 constitutes a plurality of rendering pixel units 15 arranged in an array. Each rendering pixel unit 15 includes at least two adjacent sub-pixel units 14 in a row of sub-pixel units 14, and the number of sub-pixel units 14 included in each rendering pixel unit 15 is smaller than the total number of colors corresponding to color resists in the display panel. In each row of sub-pixel units 14, at least two rendering pixel units 15 are disposed between two adjacent touch lines 13. In each column of rendering pixel units 15, each rendering pixel unit 15 can perform color rendering with its adjacent sub-pixel units 14.

As shown in FIG. 1, the display panel includes a plurality of sub-pixel units 14 arranged in an array. The display panel includes red resists, blue resists, green resists, and white resists. Each sub-pixel unit 14 corresponds to a color resist of one color. In a row of sub-pixel units 14, color resists of the abovementioned four colors are alternately arranged. A sub-pixel unit 14R corresponding to the red resist and a sub-pixel unit 14G corresponding to the green resist constitute a first rendering pixel unit 151. A sub-pixel unit 14B corresponding to the blue resist and a sub-pixel unit 14W corresponding to the white resist constitute a second rendering pixel unit 152. Each rendering pixel unit 15 can perform color rendering with its adjacent sub-pixel units 14, such that this rendering pixel unit 15 is capable of displaying a corresponding color. For example, as for the first rendering pixel unit 151 shown in a dashed outline in FIG. 1, this first rendering pixel unit 151 can perform color rendering with sub-pixel units 14B corresponding to blue resists of second rendering pixel units 152 located at upper, lower, left, and right sides of this first rendering pixel unit 151, such that this first rendering pixel unit 151 can display a corresponding color. As for the second rendering pixel unit 152 located at the left side of the first rendering pixel unit 151 shown in the dashed outline in FIG. 1, this second rendering pixel unit 152 can perform color rendering with sub-pixel units 14 corresponding to color resists of first rendering pixel units 151 located at upper, lower, left, and right sides of this second rendering pixel unit 152, such that this second rendering pixel unit 152 can display a corresponding color. At the same time, every two columns of rendering pixel units 15 corresponds to one touch line 13.

It should be noted that in the display panel shown in FIG. 1, the sub-pixel units 14W corresponding to white resists are not used for color rendering, but function to increase brightness of the display panel.

With the abovementioned design, each rendering pixel unit 15 includes two adjacent sub-pixel units 14 in a row of sub-pixel units 14, and the number of sub-pixel units 14 included in each rendering pixel unit 15 is smaller than the total number of colors corresponding to color resists included in the display panel. In each column of rendering pixel units 15, each rendering pixel unit 15 can perform color rendering, i.e., light-synthesis, with its adjacent sub-pixel units 14. In the related art, the number of sub-pixel units included in one pixel unit is equal to the total number of colors corresponding to color resists included in the display panel, and light-synthesis is performed by using sub-pixel units 14 included in the pixel unit itself. Therefore, the number of sub-pixel units 14 included in each rendering pixel unit 15 according to the embodiments of the present disclosure is smaller than the number of sub-pixel units included in each pixel unit in the related art. In addition, in the embodiments of the present disclosure, in a row of sub-pixel units 14, two rendering pixel units 15 are arranged between every two adjacent touch lines 13, i.e., every two columns of rendering pixel units 15 correspond to one touch line 13, whereas in the related art, each column of pixel units corresponds to one touch line 13. Therefore, in the case in which the display panel in the embodiments of the present disclosure and the display panel in the related art have a same area and a same pixel density (i.e., a same PPI), the number of the touch lines 13 provided in the display panel can be smaller than that in the related art. In addition, in the case in which the display panel in the embodiments of the present disclosure and the display panel in the related art have a same area and a same increased pixel density, since every two columns of rendering pixel units 15 correspond to a respective one touch line 13 in the embodiments of the present disclosure, whereas each column of rendering pixel units 15 corresponds to a respective one touch line 13 in the related art, the number of touch lines 13 provided on the display panel can be decreased according to the embodiments of the present disclosure, thereby increasing an aperture ratio of the display panel and thus increasing brightness of the display panel. At the same time, in the case in which the display panel in the embodiments of the present disclosure and the display panel in the related art have a same area and each sub-pixel unit 14 occupies a same area, i.e., the number of sub-pixel units 14 included in the display panel in the embodiments of the present disclosure and the number of sub-pixel units 14 included in the display panel in the related art have a same value, since the number of sub-pixel unit 14 included in each rendering pixel unit 15 in the embodiments of the present disclosure is smaller than the number of sub-pixel units included in each pixel unit in the related art, the number of rendering pixel units 15 included in the display panel in the embodiments of the present disclosure is larger than that in the related art, such that the pixel density of the display panel according to the embodiments of the present disclosure is larger.

It should be noted that the color resists in the display panel can include a red resist, a blue resist, a green resist, and a yellow color resist, and of course, the display panel can also include a color resist of other colors, which may be provided according to actual needs, and will not be limited herein. In addition, it is also possible that the rendering pixel unit includes three sub-pixel units, and the number of the sub-pixel units included in the rendering pixel unit may be provided according to actual needs, as long as the number of sub-pixel units included in each rendering pixel unit is smaller than the total number of colors corresponding to color resists in the display panel and each rendering pixel unit can perform color rendering together with sub-pixel units adjacent to this rendering pixel unit. When performing color rendering, the rendering manner can be determined according to actual needs, which will not be limited herein. When arranging touch lines, it may be arranged that every three columns of rendering pixel units or every four columns of rendering pixel units correspond to a respective one touch line, and the arrangement manner can be determined according to actual needs, as long as it satisfies touch requirement.

As shown in FIG. 1, a plurality of data lines 12 intersects with a plurality of scanning lines 11 in an insulation manner so as to define a plurality of sub-pixel units 14. Each sub-pixel unit 14 includes a thin film transistor (not shown) and a pixel electrode (not shown). The thin film transistor includes a source electrode electrically connected to a corresponding data line 12, a drain electrode electrically connected to a corresponding pixel electrode via a through hole, and a gate electrode electrically connected to a corresponding scanning line 11. After the thin film transistor corresponding to the pixel electrode is turned on via the scanning line 11, the source electrode and the drain electrode of the thin film transistor are electrically connected, and the corresponding data line 12 charges the corresponding pixel electrode via the source electrode and the drain electrode of the thin film transistor, such that the pixel electrode has a certain potential. By adjusting a potential difference between the pixel electrode and a common electrode (not shown), liquid crystal molecules in the liquid crystal layer (not shown) can be controlled to rotate, thereby achieving display function of the display panel.

In an embodiment, as shown in FIG. 1, the plurality of sub-pixel units 14 includes a sub-pixel unit 14 corresponding to a first color resist, a sub-pixel unit 14 corresponding to a second color resist, a sub-pixel unit 14 corresponding to a third color resist, and a sub-pixel unit 14 corresponding to a fourth color resist. As for each row of sub-pixel units 14, sub-pixel units 14 corresponding to different color resists are alternately arranged in sequence. Among four sub-pixel units 14 adjacent to a same sub-pixel unit 14, color resists corresponding to two sub-pixel units 14 in the row direction have different colors (i.e., a color resist of the sub-pixel unit 14 located at the left side of the sub-pixel unit 14 and a color resist of the sub-pixel unit 14 located at the right side of the sub-pixel unit 14 have different colors), and color resists corresponding to two sub-pixel units 14 in the column direction have a same color (i.e., a color resist of the sub-pixel unit 14 located at the upper side of the sub-pixel unit 14 and a color resist of the sub-pixel unit 14 located at the lower side of the sub-pixel unit 14 have a same color). The colors of the color resists corresponding to the two sub-pixel units 14 in the row direction are different from the color of the color resists corresponding to the two sub-pixel units 14 in the column direction.

As shown in FIG. 1, the display panel includes a sub-pixel unit 14R corresponding to the red resist, a sub-pixel unit 14B corresponding to the blue resist, a sub-pixel unit 14G corresponding to the green resist, and a sub-pixel unit 14W corresponding to the white resist. In each row of sub-pixel units 14, sub-pixel units 14 corresponding to the four color resists (i.e., red resists, blue resists, green resists, and white resists) are alternately arranged in sequence. Taking the sub-pixel units 14R corresponding to the red resists as an example, as shown in the dashed outline in FIG. 1, sub-pixel units 14B corresponding to the blue resist are arranged in the upper and lower sides of the sub-pixel unit 14R corresponding to the red resist, a sub-pixel unit 14W corresponding to the white resist is arranged in the left side of the sub-pixel unit 14R, and a sub-pixel unit 14G corresponding to the green resist is arranged in the right side of the sub-pixel unit 14R. With this structure, after sub-pixel units 14 on the display panel constitute a rendering pixel unit 15, the rendering pixel unit 15 can perform color rendering by virtue of its adjacent sub-pixel units 14. For example, as for the first rendering pixel unit 151 in the dashed outline in FIG. 1 constituted by a sub-pixel unit 14R corresponding to the red resist and a sub-pixel unit 14G corresponding to the green resist, color rendering can be performed by virtue of sub-pixel units 14B corresponding to blue resists in second rendering pixel units 152 located at the upper side, lower side, left side, and right side of this first rendering pixel unit 151, such that the first rendering pixel unit 151 can display a corresponding color. Here, when the first rendering pixel unit 151 performs color rendering, the color rendering can be performed by virtue of partial light emitted from sub-pixel units 14B corresponding to blue resists in second rendering pixel units 152 located at the upper side, lower side, left side, and right side of this first rendering pixel unit 151.

It should be noted that the arrangement manner of the sub-pixel units 14 in FIG. 1 is merely illustrative, and it is also possible that sub-pixel units 14R corresponding to red resists and sub-pixel units 14G corresponding to green resists constitute a first rendering pixel unit 151, and sub-pixel units 14W corresponding to white resists and sub-pixel unit 14Bs corresponding to blue resists constitute a second rendering pixel unit 152. Still, it is also possible that the sub-pixel unit 14R corresponding to the red resist and the sub-pixel unit 14W corresponding to the white resist constitute the first rendering pixel unit 151, and the sub-pixel unit 14G corresponding to the green resist and the sub-pixel unit 14B corresponding to the blue resist constitute the second rendering pixel unit 152. Still, it is also possible that the sub-pixel unit 14R corresponding to the red resist and the sub-pixel unit 14B corresponding to the blue resist constitute the first rendering pixel unit 151, and the sub-pixel unit 14W corresponding to the white resist and the sub-pixel unit 14G corresponding to the green resist constitute the second rendering pixel unit 152. No matter which arrangement manner is adopted, it should satisfy that among four sub-pixel units 14 adjacent to a same sub-pixel unit 14, color resists corresponding to the two sub-pixel units 14 in the row direction have different colors and color resists corresponding to the two sub-pixel units 14 in the column direction have a same color, and that the colors of the color resists corresponding to the two sub-pixel units 14 in the row direction are different from the color of the color resists corresponding to the two sub-pixel units 14 in the column direction.

It should be noted that when a pixel unit in the related art includes sub-pixel units corresponding to the abovementioned four color resists, and the embodiments of the present disclosure adopt the structure as shown in FIG. 1, the number of touch lines can be decreased by half in the embodiments of the present disclosure with compared with that in the related art, assuming that PPI in the embodiments of the present disclosure and PPI in the related art have a same value, or, PPI of the display panel can be doubled with respect to that in the related art when display area in the embodiments of the present disclosure and a display area in the related art have a same value.

In an embodiment, as shown in FIG. 1, when each rendering pixel unit 15 includes two adjacent sub-pixel units 14 in a row of sub-pixel units 14, the rendering pixel units 15 include a first rendering pixel unit 151 and a second rendering pixel unit 152, four first rendering pixel units 151 are arranged to surround a respective one second rendering pixel unit 152, and four second rendering pixel units 152 are arranged to surround a respective one first rendering pixel unit 151.

As shown in FIG. 1, a sub-pixel unit 14R corresponding to the red resist and a sub-pixel unit 14G corresponding to the green resist constitute a first rendering pixel unit 151, and a sub-pixel unit 14W corresponding to the white resist and a sub-pixel unit 14B corresponding to the blue resist constitute a second rendering pixel unit 152. Taking a first rendering pixel unit 151 as an example, the first rendering pixel unit 151 is surrounded by four second rendering pixel units 152. Taking a second rendering pixel 152 as an example, the second rendering pixel unit 152 is surrounded by four first rendering pixel units 151. With this arrangement, mutual rendering between respective rendering pixel units 15 can be facilitated.

In an embodiment, as shown in FIG. 1, the first rendering pixel unit 151 includes a sub-pixel unit 14 corresponding to a first color resist and a sub-pixel unit 14 corresponding to a second color resist, and the second rendering pixel unit 152 includes a sub-pixel unit 14 corresponding to a third color resist and a sub-pixel unit 14 corresponding to a fourth color resist. The first rendering pixel unit 151 can perform color rendering together with the four second rendering pixel units 152 surrounding it.

As shown in FIG. 1, the sub-pixel unit 14R corresponding to the red resist and the sub-pixel unit 14G corresponding to the green resist constitute the first rendering pixel unit 151, and the sub-pixel unit 14W corresponding to the white resist and the sub-pixel unit 15B corresponding to the blue resist constitute the second rendering pixel unit 152. Taking a first rendering pixel unit 151 as an example, four second rendering pixel units 152 surrounding the first rendering pixel unit 151 each includes a sub-pixel unit 14B corresponding to the blue resist and a sub-pixel unit 14W corresponding to the white resist, and it is still blue after light synthesis is performed by the second rendering pixel unit 152. The first rendering pixel unit 151 performs color rendering by virtue of partial brightness from the four second rendering pixel units 152 surrounding it, so that the first rendering pixel unit 151 can display a corresponding color. Since the pixel density of the display panel is proportional to the number of rendering pixel units 15 per unit area in the display panel, with the abovementioned structure, each sub-pixel unit 14 in the display panel corresponds to a rendering pixel unit 15 such that the rendering pixel units 15 can be distributed on the display panel in an array. Compared with the related art, the pixel density of the display panel can be improved to a certain extent in embodiments of the present disclosure.

In an example, as shown in FIG. 1, one of the color resists is a white resist 14W.

As shown in FIG. 1, one of the color resists is a white resist 14W. Since the white resist 14W have all light directed thereto transmitted, with the structure shown in FIG. 1, transmittance of the display can be improved, such that brightness of the display panel can be increased. In an embodiment, as shown in FIG. 1, in the row direction, the sub-pixel unit 14W corresponding to the white resist has a smaller width than the sub-pixel unit 14 corresponding to other color resist. The plurality of touch lines 13 is evenly arranged at a side of the sub-pixels 14W corresponding to the white resist in an odd-numbered or even-numbered row of sub-pixels.

As shown in FIG. 1, every two rendering pixel units 15 correspond to a respective one touch line 13. In the display panel, the width of the sub-pixel unit 14W corresponding to the white resist is smaller than that of the sub-pixel unit 14 corresponding to other color resist, that is, aperture ratio of the sub-pixel unit 14W corresponding to the white resist is smaller than that of the sub-pixel unit 14 corresponding to other color resist. The sub-pixel unit 14W corresponding to the white resist contributes less brightness to the display panel than other color resists, whereas the sub-pixel unit 14 contributing less brightness to the display panel has a smaller influence on the brightness of the display panel when the aperture ratio of this sub-pixel unit changes. Therefore, the influence on brightness of the display panel can be decreased when the width of the sub-pixel unit 14W corresponding to the white resist is designed to be smaller than the width of the sub-pixel unit 14 corresponding to other color resist. Besides, when the plurality of touch lines 13 is arranged at a side of the sub-pixels 14W corresponding to white resist in an odd-numbered or even-numbered row of sub-pixels, the touch line 13 may be provided in a space of the reduced portion of the sub-pixel unit 14W corresponding to the white resist, thereby reducing the influence of the touch line 13 on an overall aperture ratio of the display panel.

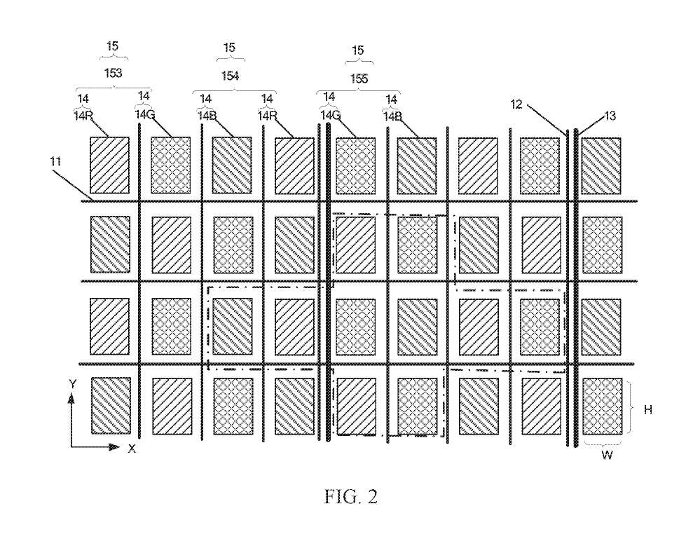

In an embodiment, as shown in FIG. 2, which is a top view of another display panel according to an embodiment of the present disclosure, a plurality of sub-pixel units 14 includes a sub-pixel units 14 corresponding to a first color resists, a sub-pixel units 14 corresponding to a second color resist, and a sub-pixel units 14 corresponding to a third color resist. As for a row of sub-pixel units 14, the sub-pixel units 14 corresponding to different color resists are alternately arranged in sequence. Among four sub-pixel units 14 adjacent to a same sub-pixel unit 14, color resists corresponding to two sub-pixel units 14 in the row direction have different colors, and color resists corresponding to two sub-pixel units 14 in the column direction have a same color. Moreover, the color of the color resist corresponding to the one sub-pixel unit 14 in the row direction is different from the color of the color resists corresponding to the two sub-pixel units 14 in the column direction, and the color of the color resist corresponding to the other sub-pixel unit 14 in the row direction is the same as the color of the color resists corresponding to the two sub-pixel units 14 in the column direction.

As shown in FIG. 2, the display panel includes sub-pixel units 14R corresponding to red resists, sub-pixel units 14B corresponding to blue resists, and sub-pixel units 14G corresponding to green resists. As for a row of sub-pixel units 14, the sub-pixel units 14 corresponding to the three color resists are alternately arranged in sequence. Taking the sub-pixel unit 14G corresponding to the green resist as an example, as shown in the dashed outline in FIG. 2, the sub-pixels 14R corresponding to the red resist are respectively arranged at the upper side, lower side, and left side of the sub-pixel unit 14G corresponding to the green resist, and a sub-pixel unit 14B corresponding to the blue resist are arranged at the right side of the sub-pixel unit 14G corresponding to the green resist. With this arrangement, after sub-pixel units 14 on the display panel constitute a rendering pixel unit 15, the rendering pixel unit 15 can perform color rendering by virtue of respective sub-pixel units 14 in its adjacent rendering pixel unit 15. For example, as shown in the dashed outline in FIG. 2, a sub-pixel unit 14G corresponding to the green resist and a sub-pixel unit 14B corresponding to the blue resist constitute a rendering pixel unit 15, and then color rendering is performed by virtue of its adjacent three sub-pixel units 14R corresponding to the red resists R.

With the structure as shown in FIG. 2, since each rendering pixel unit 15 includes two sub-pixel units 14 adjacent to each other in a row of sub-pixel units 14, and the number of sub-pixel units 14 included in each rendering pixel unit 15 is smaller than the total number of colors corresponding to color resists included in the display panel. In each column of rendering pixel units 15, each rendering pixel unit 15 can perform color rendering, i.e., light-synthesis, with its adjacent sub-pixel unit 14. In the related art, the number of sub-pixel units included in each pixel unit is equal to the total number of colors corresponding to color resists included in the display panel, and light-synthesis is performed by sub-pixel units 14 included in the pixel unit itself. Therefore, the number of sub-pixel units 14 included in each rendering pixel unit 15 in the embodiments of the present disclosure is smaller than the number of sub-pixel units included in each pixel unit in the related art. In addition, in the embodiments of the present disclosure, in a row of sub-pixel units 14, two rendering pixel units 15 are arranged between every two adjacent touch lines 13, i.e., every two columns of rendering pixel units 15 correspond to a respective one touch line 13, whereas in the related art, each column of rendering pixel units 15 corresponds to a respective one touch line. Therefore, in the case in which the display panel in the embodiments of the present disclosure and the display panel in the related art have a same area and a same pixel density (i.e., the number of smallest units for light-synthesis in the embodiments of the present disclosure and the number of smallest units for light-synthesis in the related art have a same value), the number of touch lines 13 provided in the display panel can be smaller than that in the related art. In addition, in the case in which the display panel in the embodiments of the present disclosure and the display panel in the related art have a same area and a same increased pixel density; since every two columns of rendering pixel units 15 correspond to a respective one touch line 13 in the embodiments of the present disclosure, whereas each column of rendering pixel units 15 corresponds to a respective one touch line 13 in the related art, the number of touch lines 13 provided on the display panel can be decreased in the embodiments of the present disclosure, thereby increasing an aperture ratio of the display panel and thus increasing brightness of the display panel. At the same time, in the case in which the display panel in the embodiments of the present disclosure and the display panel in the related art have a same area and each sub-pixel unit 14 occupies a same area, i.e., the number of sub-pixel units 14 included in the display panel in the embodiments of the present disclosure and the number of sub-pixel units 14 included in the display panel in the related art have a same value, since the number of sub-pixel unit 14 included in one rendering pixel unit 15 in the embodiments of the present disclosure is smaller than the number of sub-pixel units included in one pixel unit in the related art, the number of rendering pixel units 15 included in the display panel in the embodiments of the present disclosure is larger than that in the related art, and thus the pixel density of the display panel in the embodiments of the present disclosure is larger.

It should be noted that the arrangement manner of sub-pixel units 14 shown in FIG. 2 is merely illustrative, and it may also be other arrangement manner, which will not be limited herein, as long as it satisfies that among four sub-pixel units 14 adjacent to a same sub-pixel unit 14, color resists corresponding to two sub-pixel units 14 in the row direction have different colors, color resists corresponding to two sub-pixel units 14 in the column direction have a same color, besides, the color of one of the two color resists corresponding to the two sub-pixel units 14 in the row direction is different from the color of the color resists corresponding to the two sub-pixel units 14 in the column direction, and the color of the other one of the two color resists corresponding to the two sub-pixel units 14 in the row direction is the same as the color of the color resists corresponding to the two sub-pixel units 14 in the column direction

In an embodiment, as shown in FIG. 2, when each rendering pixel unit 15 includes two sub-pixel units 14 adjacent to each other in a row of sub-pixel units 14, the rendering pixel units 15 include first rendering pixel units 153, second rendering pixel units 154, and third rendering pixel units 155. Each first rendering pixel unit 153 is surrounded by three second rendering pixel units 154 and one third rendering pixel unit 155 or is surrounded by three third rendering pixel units 155 and one second rendering pixel unit 154. Each second rendering pixel unit 154 is surrounded by three third rendering pixel units 155 and one first rendering pixel unit 153 or is surrounded by three first rendering pixel units 153 and one third rendering pixel unit 155. Each third rendering pixel unit 155 is surrounded by three second rendering pixel units 154 and one first rendering pixel unit 153 or is surrounded by three first rendering pixel units 153 and one second rendering pixel unit 154.

As shown in FIG. 2, a sub-pixel unit 14R corresponding to the red resist and a sub-pixel unit 14G corresponding to the green resist constitute a first rendering pixel unit 153, a sub-pixel unit 14B corresponding to the blue resist and a sub-pixel unit 14R corresponding to the red resist constitute a second rendering pixel unit 154, a sub-pixel unit 14G corresponding to the green resist and a sub-pixel unit 14B corresponding to the blue resist constitute a third rendering pixel unit 155. Taking a third rendering pixel unit 155 as an example, the third rendering pixel unit 155 is surrounded by three first rendering pixel units 153 and one second rendering pixel unit 154. Taking a second rendering pixel unit 154 as an example, the second rendering pixel unit 154 is surrounded by three third rendering pixel units 155 and one second rendering pixel unit 154. Taking a first rendering pixel unit 153 as an example, the first rendering pixel unit 153 is surrounded by three second rendering pixel units 154 and one third rendering pixel unit 155. With this arrangement, the mutual rendering between respective rendering pixel units 15 can be facilitated.

In an embodiment, as shown in FIG. 2, a first rendering pixel unit 153 includes a sub-pixel unit 14 corresponding to a first color resist and a sub-pixel unit 14 corresponding to a second color resist, a second rendering pixel unit 154 includes a sub-pixel unit 14 corresponding to a first color resist and a sub-pixel unit 14 corresponding to a third color resist, and a third rendering pixel unit 155 includes a sub-pixel unit 14 corresponding to a second color resist and a sub-pixel unit 14 corresponding to a third color resist. Each rendering pixel unit 15 can perform color rendering with the four rendering pixel units 15 surrounding it.

As shown in FIG. 2, a sub-pixel unit 14R corresponding to the red resist and a sub-pixel unit 14G corresponding to the green resist constitute a first rendering pixel unit 153, a sub-pixel unit 14B corresponding to the blue resist and a sub-pixel unit 14R corresponding to the red resist constitute a second rendering pixel unit 154, a sub-pixel unit 14G corresponding to the green resist and a sub-pixel unit 14B corresponding to the blue resist constitute a third rendering pixel unit 155. Taking a third rendering pixel unit 155 as an example, as shown in the dashed outline in FIG. 2, rendering pixel units 15 surrounding the third rendering pixel unit 155 include three first rendering pixel units 153 and one second rendering pixel unit 154, and the third rendering pixel unit 155 performs color rendering respectively by virtue of partial brightness of the four rendering pixel units 154 surrounding the third rendering pixel unit 155, such that the third rendering pixel unit 155 can display a corresponding color. Since the pixel density of the display panel is proportional to the number of rendering pixel units 15 per unit area in the display panel, with the abovementioned structure shown in FIG. 2, each sub-pixel unit 14 in the display panel corresponds to a rendering pixel unit 15 so that the rendering pixel units 15 can be distributed on the display panel in an array. Compared with the related art, the pixel density of the display panel can be improved to a certain extent in embodiments of the present disclosure.

In an embodiment, as shown in FIG. 2, each sub-pixel unit 14 has a height H in the column direction and a width W in the row direction, where H:W=2:1.

As shown in FIG. 2, each rendering pixel unit 15 includes two sub-pixel units, and each rendering pixel unit 15 is a minimum display unit for displaying an image on the display panel, in order to achieve that each rendering unit displays a corresponding image which is the same as an original image so as to allow the entire display panel to display the original image without distortion (i.e., without lengthening or widening the original image), it is required that a length-width ratio of each rendering pixel unit 15 has a same value as much as possible when each rendering pixel unit 15 displays a corresponding image, and thus the length-width ratio of each sub-pixel unit needs to be 2:1 in the case in which each rendering unit 15 includes two sub-pixel units.

In an embodiment, as shown in FIG. 2, when performing a rendering algorithm, brightness contributed to each rendering pixel from each of two sub-pixel units 14 included in this rendering pixel is less than or equal to two thirds of a total brightness of this sub-pixel unit 14.

With reference to FIG. 2, as shown in the dashed outline in FIG. 2, a third rendering pixel unit 155 includes a sub-pixel unit 14G corresponding to the green resist and a sub-pixel unit 14B corresponding to the blue resist. When the third rendering pixel unit 155 performs color rendering, brightness contributed to the third rendering pixel unit 155 by the sub-pixel unit 14G corresponding to the green resist is not more than two thirds of maximum brightness of the sub-pixel unit 14G corresponding to the green resist, the brightness contributed to the third rendering pixel unit 155 from the sub-pixel unit 14B corresponding to the blue resist is not smaller than two thirds of the maximum brightness of the sub-pixel unit 14B corresponding to the blue resist, and the remaining brightness of the sub-pixel unit 14G corresponding to the green resist and the remaining brightness of the sub-pixel unit 14B corresponding to the blue resist are provided to the adjacent rendering pixel unit 15 for color rendering. For example, the brightness contributed to the third rendering pixel unit 155 from the sub-pixel unit 14G corresponding to the green resist is two thirds of the maximum brightness of the sub-pixel unit 14G corresponding to the green resist, and the remaining one third of the maximum brightness of the sub-pixel unit 14G corresponding to the green resist is provided to a second rendering pixel unit 154 located at its left side, brightness contributed to the third rendering pixel unit 155 from the sub-pixel unit 14B corresponding to the blue resist is two thirds of the maximum brightness of the sub-pixel unit 14B corresponding to the blue resist, and the remaining one third of the maximum brightness of the sub-pixel unit 14B corresponding to the blue resist is evenly provided to first rendering pixel units 153 located at its upper side, left side, and lower side, respectively.

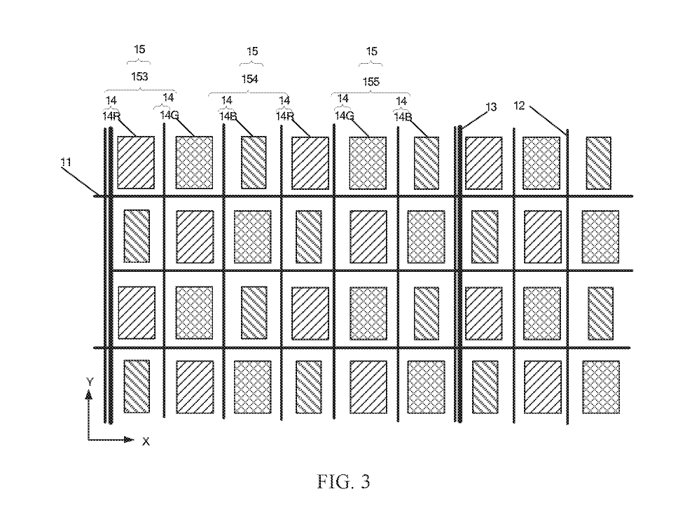

In an embodiment, as shown in FIG. 3, which is a top view of another display panel according to an embodiment of the present disclosure, the color resists include a blue resist.

In an embodiment, as shown in FIG. 3, in the row direction, the sub-pixel unit 14B corresponding to the blue resist has a smaller width than that of the sub-pixel unit 14 corresponding to other color resist. The plurality of touch lines 13 is evenly arranged at a side of the sub-pixels 14B corresponding to the blue resist in an odd-numbered or even-numbered row of sub-pixels.

As shown in FIG. 3, every three rendering pixel units 15 correspond to a respective one touch line 13. Besides, in the display panel, the sub-pixel unit 14B corresponding to the blue resist has a smaller width than that of the sub-pixel unit 14 corresponding to other color resist, that is, an aperture ratio of the sub-pixel unit 14B corresponding to the blue resist is smaller than an aperture ratio of the sub-pixel unit 14R corresponding to the red resist and an aperture ratio of the sub-pixel unit 14G corresponding to the green resist. The brightness contributed to the display panel from the sub-pixel unit 14B corresponding to the blue resist is smaller than the brightness contributed to the display panel from the sub-pixel unit 14 corresponding to other color resist, the sub-pixel unit 14 contributing least brightness to the display panel has a smaller influence on the brightness of the display panel when the aperture ratio of this sub-pixel unit changes. Therefore, the influence on brightness of the display panel can be decreased when it is arranged that the width of the sub-pixel unit 14B corresponding to the blue resist is smaller than the width of the sub-pixel unit 14 corresponding to other color resist. Besides, when the plurality of touch lines 13 is evenly arranged at a side of the sub-pixels 14B corresponding to the blue resist in an odd-numbered or even-numbered row of sub-pixels, the touch lines 13 may be provided in a space of the reduced portion of the sub-pixel unit 14B corresponding to the blue resist, thereby reducing influence of the touch line 13 on an overall aperture ratio of the display panel.

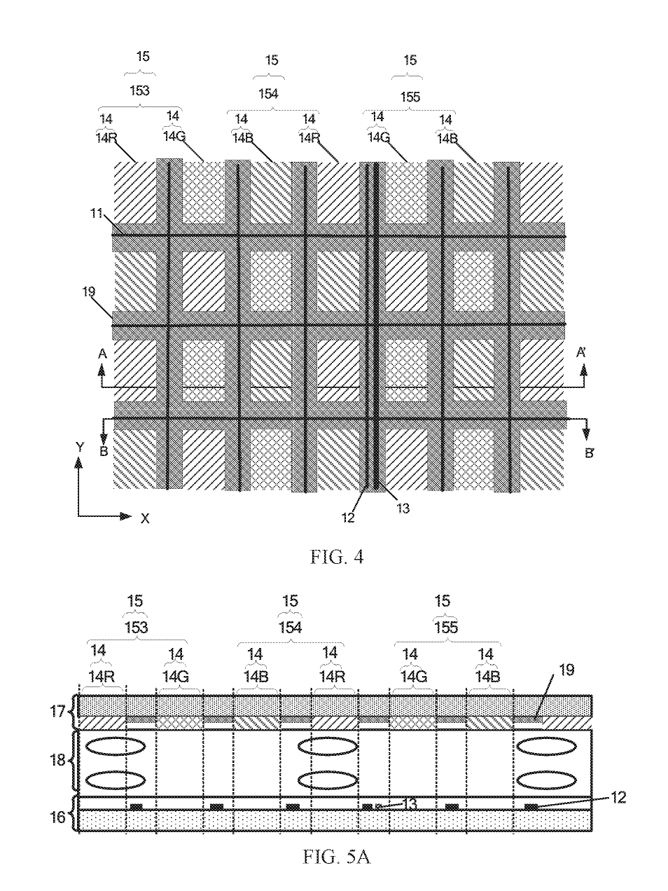

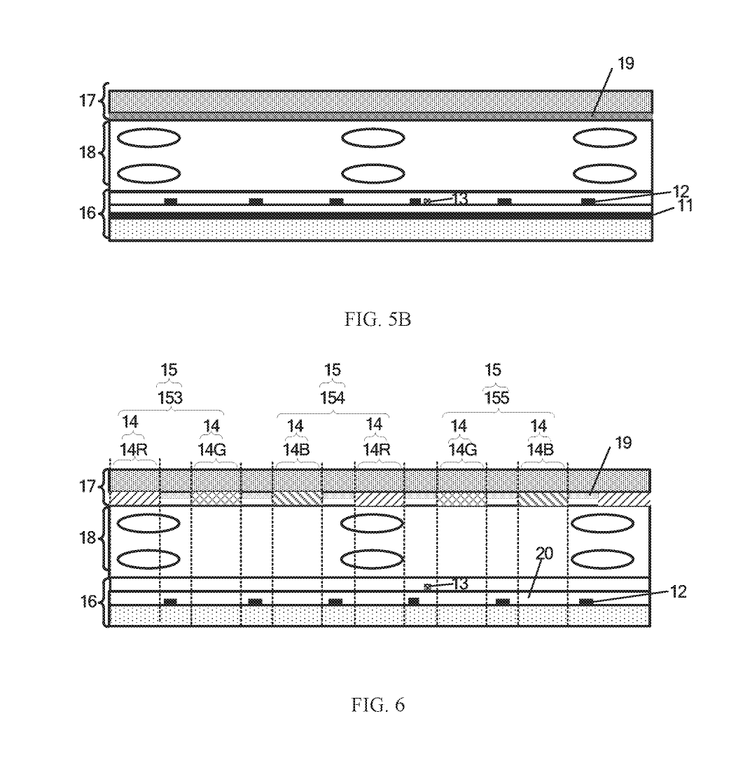

FIG. 4 is a top view of still another display panel according to an embodiment of the present disclosure. FIG. 5A is a cross-section view along line AA′ in FIG. 4, and FIG. 5B is a cross-section view along line BB′ in FIG. 4. The display panel further includes: a first substrate 16; a second substrate 17 disposed opposite to the first substrate 16; a liquid crystal layer 18 disposed between the first substrate 16 and the second substrate 17; a plurality of scanning lines 11, a plurality of data lines 12 and a plurality of touch lines 13, disposed at a side of the first substrate 16 facing toward the second substrate 17; a color resist layer, including different color resists and disposed at a side of the second substrate 17 facing toward the first substrate 16; and a black matrix 19 disposed on a surface of the second substrate 17 provided with the color resist layer. An orthographic projection of the touch line 13 on the first substrate 16 is within an orthographic projection of the black matrix 19 on the first substrate 16.

As shown in FIG. 4, FIG. 5A and FIG. 5B, since wiring in the display panel is located in the non-luminous region in the display panel, in order to prevent wiring pattern in the display panel from being displayed on the display panel, which would otherwise affect display effect, the wiring needs to be blocked. The black matrix 19 is provided on the display panel and includes a plurality of aperture regions, and the sub-pixel units 14 are disposed in the aperture regions, such that the black matrix 19 can block the non-luminous region in the display panel and thus the wiring pattern in the display panel may not be displayed on the display panel.

In an embodiment, as shown in FIG. 5A and FIG. 5B, a plurality of data lines 12 and a plurality of touch lines 13 are disposed parallel to each other and located in a same layer.

As shown in FIG. 5A and FIG. 5B, in the case in which the plurality of data lines 12 and the plurality of touch lines 13 are disposed parallel to each other and located in a same layer, a thickness of the display panel can be decreased, and the plurality of data lines 12 and the plurality of touch lines 13 can be manufactured in a same layer, thereby reducing process complexity of the display panel.

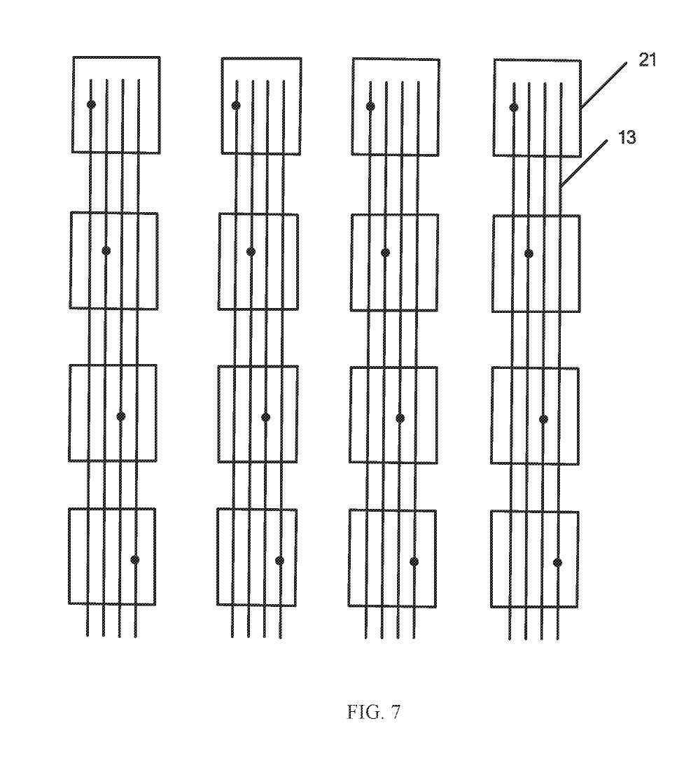

In an embodiment, as shown in FIG. 6, which is another cross-section view along line AA′ in FIG. 4, a plurality of data lines 12 is located in a different layer from a plurality of touch lines 13, and an insulating layer 20 is disposed between the plurality of data lines 12 and the plurality of touch lines 13.

As shown in FIG. 6, the plurality of data lines 12 is located in a different layer from the plurality of touch lines 13, and the insulating layer 20 is used to insulate the plurality of data lines 12 from the plurality of touch lines 13. With the structure shown in FIG. 6, mutual interference between the data lines 12 and the touch lines 13 can be decreased. Here, when the date lines are located in a different layer from the touch lines, an orthographic projection of the data lines on the display panel may or may not overlap an orthographic projection of the touch lines on the display panel.

In an embodiment, as shown in FIG. 7, which is a top view of still another display panel according to an embodiment of the present disclosure, the display panel further includes: a plurality of touch electrode blocks 21 arranged in an array, each of which is electrically connected to at least one touch line 13. The touch electrode blocks 21 are multiplexed into a common electrode during the displaying stage.

As shown in FIG. 7, each of the plurality of touch electrode blocks 21 arranged in an array is a self-capacitance touch electrode 21, and each touch electrode block 21 can form a capacitor together with earth at a zero potential, i.e., forming a self-capacitance channel. Each touch electrode block 21 achieves inputting the touch driving signal and outputting the touch detecting signal via the touch lines 13 connected to this touch electrode block 21. The display panel determines a touch position via the touch driving signal and the touch detecting signal. An operating period of the display panel can be divided into a touching stage and a displaying stage. During the touching stage, the display panel can perform touch control. During displaying stage, the display panel can perform displaying control. The touching stage can alternate with the displaying stage.

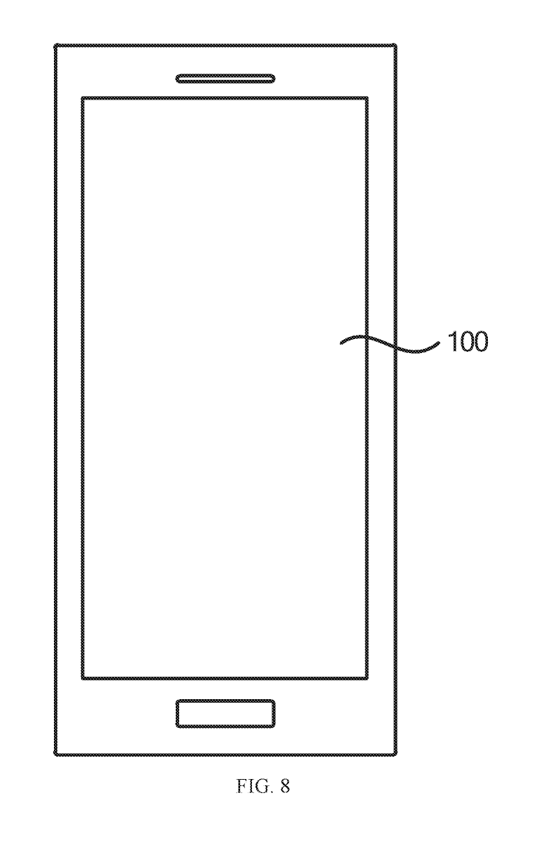

As shown in FIG. 8, which is a schematic diagram of a display device according to an embodiment of the present disclosure, the display device includes the abovementioned display panel 100. The structure and principle of the display panel 100 are the same as those in the above embodiments, which will not be repeated herein.

It should be noted that the display devices in the embodiments of the present disclosure may include but is not limited to any electrical device having a liquid crystal display function, such as a personal computer (PC), a personal digital assistant (PDA), a wireless handheld device, a tablet computer, a mobile phone, an mp4 player, a television and the like.

The above-described embodiments are merely embodiments of the present disclosure and are not intended to limit the present disclosure. Any modifications, equivalent substitutions and improvements made within the principle of the present disclosure shall fall into the protection scope of the present disclosure.

What is claimed is:

1. A display panel, comprising:
a plurality of scanning lines extending along a first direction and arranged along a second direction;
a plurality of data lines extending along the second direction and arranged along the first direction;
a plurality of touch lines extending along the second direction and arranged along the first direction, wherein the first direction is perpendicular to and intersects the second direction; and
a plurality of sub-pixel units defined by the plurality of data lines intersecting the plurality of scanning lines in an insulation manner, the plurality of sub-pixel units constituting a plurality of rendering pixel units arranged in an array,
wherein each of the plurality of rendering pixel units comprises at least two adjacent sub-pixel units in a row of sub-pixel units, and a number of sub-pixel units comprised in each of the plurality of rendering pixel units is smaller than a total number of colors corresponding to color resists in the display panel,
wherein in each row of sub-pixel units, at least two rendering pixel units of the plurality of rendering pixel units are disposed between two adjacent touch lines of the plurality of touch lines, and
wherein in each column of rendering pixel units, each rendering pixel unit performs color rendering with its adjacent sub-pixel unit.

2. The display panel according to claim 1, wherein the plurality of sub-pixel units comprises a sub-pixel unit corresponding to a first color resist, a sub-pixel unit corresponding to a second color resist, a sub-pixel unit corresponding to a third color resist, and a sub-pixel unit corresponding to a fourth color resist, and sub-pixel units corresponding to different color resists are alternately arranged in a row direction, and
wherein among four sub-pixel units adjacent to a same sub-pixel unit, color resists corresponding to two of the four sub-pixel units in the row direction have different colors, color resists corresponding to the other two of the four sub-pixel units in a column direction have a same color, and the colors of the color resists corresponding to the two of the four sub-pixel units in the row direction are different from the color of the color resists corresponding to the other two of the four sub-pixel units in the column direction.

3. The display panel according to claim 2, wherein each of the plurality of rendering pixel units comprises two adjacent sub-pixel units in the row of sub-pixel units, the plurality of rendering pixel units comprises a plurality of first rendering pixel units and a plurality of second rendering pixel units, wherein four first rendering pixel units of the plurality of first rendering pixel units are arranged to surround a respective second rendering pixel unit of the plurality of second rendering pixel units, and four second rendering pixel units of the plurality of second rendering pixel units are arranged to surround a respective first rendering pixel unit of the plurality of first rendering pixel units.

4. The display panel according to claim 3, wherein each of the plurality of first rendering pixel units comprises the sub-pixel unit corresponding to the first color resist and the sub-pixel unit corresponding to the second color resist, each of the plurality of second rendering pixel units comprises the sub-pixel unit corresponding to the third color resist and the sub-pixel unit corresponding to the fourth color resist, and each of the plurality of first rendering pixel units performs color rendering with the four second rendering pixel units surrounding the first rendering pixel unit.

5. The display panel according to claim 4, wherein one of the first, second, third and fourth color resists is a white resist.

6. The display panel according to claim 5,
wherein in the row direction, a sub-pixel unit corresponding to the white resist has a width smaller than a width of a sub-pixel unit corresponding to other color resists, and
wherein the plurality of touch lines is evenly arranged to be adjacent to the sub-pixel unit corresponding to the white resist in an odd-numbered or even-numbered row of sub-pixels.

7. The display panel according to claim 1,
wherein the plurality of sub-pixel units comprises a sub-pixel unit corresponding to a first color resist, a sub-pixel unit corresponding to a second color resist and a sub-pixel unit corresponding to a third color resist, and sub-pixel units corresponding to different color resists are alternately arranged in a row direction, and
wherein among four sub-pixel units adjacent to a same sub-pixel unit, color resists corresponding to two of the four sub-pixel units in the row direction have different colors, color resists corresponding to the other two of the four sub-pixel units in a column direction have a same color, a color of one of the color resists corresponding to the two of the four sub-pixel units in the row direction is different from the color of the color resists corresponding to the other two of the four sub-pixel units in the column direction, and a color of the other one of the color resists corresponding to the two of the four sub-pixel units in the row direction is the same as the color of the color resists corresponding to the other two of the four sub-pixel units in the column direction.

8. The display panel according to claim 7, wherein each of the plurality of rendering pixel units comprises two adjacent sub-pixel units in the row of sub-pixel units, the plurality of rendering pixel units comprises a plurality of first rendering pixel units, a plurality of second rendering pixel units, and a plurality of third rendering pixel units,
wherein each of the plurality of first rendering pixel units is surrounded by three of the plurality of second rendering pixel units and one of the plurality of third rendering pixel units, or each of the plurality of first rendering pixel units is surrounded by three of the plurality of third rendering pixel units and one of the plurality of second rendering pixel units,
wherein each of the plurality of second rendering pixel units is surrounded by three of the plurality of third rendering pixel units and one of the plurality of first rendering pixel units, or each of the plurality of second rendering pixel units is surrounded by three of the plurality of first rendering pixel units and one of the plurality of third rendering pixel units, and
wherein each of the plurality of third rendering pixel units is surrounded by three of the plurality of second rendering pixel units and one of the plurality of first rendering pixel units, or each of the plurality of third rendering pixel units is surrounded by three of the plurality of first rendering pixel units and one of the plurality of second rendering pixel units.

9. The display panel according to claim 8, wherein each the plurality of first rendering pixel units comprises the sub-pixel unit corresponding to the first color resist and the sub-pixel unit corresponding to the second color resist, each the plurality of second rendering pixel units comprises the sub-pixel unit corresponding to the first color resist and the sub-pixel unit corresponding to the third color resist, and each of the plurality of third rendering pixel units comprises the sub-pixel unit corresponding to the second color resist and the sub-pixel unit corresponding to the third color resist, and
wherein each rendering pixel unit of the plurality of first, second and third rendering pixel units performs color rendering with four rendering pixel units surrounding the rendering pixel unit.

10. The display panel according to claim 8, wherein each of the sub-pixel units has a height H in the column direction and a width W in the row direction, and H:W=2:1.

11. The display panel according to claim 8, wherein when applying a rendering algorithm on the display panel, brightness provided to one rendering pixel unit of the plurality of first, second and third rendering pixel units by each of two sub-pixel units comprised in the one rendering pixel unit is smaller than or equal to two thirds of a maximal brightness of the sub-pixel unit.

12. The display panel according to claim 9, wherein the one of the first, second and third color resists is a blue resist.

13. The display panel according to claim 12,
wherein in the row direction, each sub-pixel unit corresponding to the blue resist has a width smaller than a width of each sub-pixel unit corresponding to other color resists, and
wherein the plurality of touch lines is evenly arranged to be adjacent to the sub-pixel unit corresponding to the blue resist in an odd-numbered or even-numbered row of sub-pixels.

14. The display panel according to claim 1, further comprising:
a first substrate;
a second substrate disposed opposite to the first substrate;
a liquid crystal layer disposed between the first substrate and the second substrate;
a color resist layer formed by different color resists and disposed at a side of the second substrate facing toward the first substrate; and
a black matrix disposed on a surface of the second substrate provided with the color resist layer,
wherein the plurality of scanning lines, the plurality of data lines and the plurality of touch lines are disposed at a side of the first substrate facing toward the second substrate, and wherein an orthographic projection of the plurality of touch lines on the first substrate is within an orthographic projection of the black matrix on the first substrate.

15. The display panel according to claim 1, wherein the plurality of data lines and the plurality of touch lines are parallel to each other and located in a same layer.

16. The display panel according to claim 1, wherein the plurality of data lines and the plurality of touch lines are located in different layers and an insulating layer is provided between the plurality of data lines and the plurality of touch lines.

17. The display panel according to claim 1, further comprising:
a plurality of touch electrode blocks arranged in an array, each of the plurality of touch electrode blocks being electrically connected to at least one of the plurality of touch lines,
wherein the plurality of touch electrode blocks is multiplexed as a common electrode during displaying.

18. A display device, comprising a display panel, the display panel comprising:
a plurality of scanning lines extending along a first direction and arranged along a second direction;
a plurality of data lines extending along the second direction and arranged along the first direction;
a plurality of touch lines extending along the second direction and arranged along the first direction, wherein the first direction is perpendicular to and intersects the second direction; and
a plurality of sub-pixel units defined by the plurality of data lines intersecting the plurality of scanning lines in an insulation manner, the plurality of sub-pixel units constituting a plurality of rendering pixel units arranged in an array,
wherein each of the plurality of rendering pixel units comprises at least two adjacent sub-pixel units in a row of sub-pixel units, and a number of sub-pixel units comprised in each of the plurality of rendering pixel units is smaller than a total number of colors corresponding to color resists in the display panel,
wherein in each row of sub-pixel units, at least two rendering pixel units of the plurality of rendering pixel units are disposed between two adjacent touch lines of the plurality of touch lines, and
wherein in each column of rendering pixel units, each rendering pixel unit performs color rendering with its adjacent sub-pixel unit.

19. The display device, according to claim 18, wherein the plurality of sub-pixel units comprises a sub-pixel unit corresponding to a first color resist, a sub-pixel unit corresponding to a second color resist, a sub-pixel unit corresponding to a third color resist, and a sub-pixel unit corresponding to a fourth color resist, and sub-pixel units corresponding to different color resists are alternately arranged in a row direction, and
wherein among four sub-pixel units adjacent to a same sub-pixel unit, color resists corresponding to two of the four sub-pixel units in the row direction have different colors, color resists corresponding to the other two of the four sub-pixel units in a column direction have a same color, and the colors of the color resists corresponding to the two of the four sub-pixel units in the row direction are different from the color of the color resists corresponding to the other two of the four sub-pixel units in the column direction.

20. The display device according to claim 18,
wherein the plurality of sub-pixel units comprises a sub-pixel unit corresponding to a first color resist, a sub-pixel unit corresponding to a second color resist and a sub-pixel unit corresponding to a third color resist, and sub-pixel units corresponding to different color resists are alternately arranged in a row direction, and
wherein among four sub-pixel units adjacent to a same sub-pixel unit, color resists corresponding to two of the four sub-pixel units in the row direction have different colors, color resists corresponding to the other two of the four sub-pixel units in a column direction have a same color, a color of one of the color resists corresponding to the two of the four sub-pixel units in the row direction is different from the color of the color resists corresponding to the other two of the four sub-pixel units in the column direction, and a color of the other one of the color resists corresponding to the two of the four sub-pixel units in the row direction is the same as the color of the color resists corresponding to the other two of the four sub-pixel units in the column direction.
